(19) United States
(12) Patent Application Publication
(10) Pub. No.: US 2004/0109977 A1
(43) Pub. Date: Jun. 10, 2004

(54) Dual purpose floor mat

(76) Inventors: Arthur Samuel Wildstein, Marietta, GA (US); Samuel Collins Weems, Calhoun, GA (US)

Correspondence Address: MICHAEL N. HAYNES, 1341 HUNTERSFIELD CLOSE, KESWICK, VA, 22947, US

(21) Appl. No.: 10/314,633

(22) Filed: Dec. 9, 2002

(51) Int. Cl. B32B 3/02; B32B 33/00; B29C 65/00; B29C 69/00

(52) U.S. Cl. 428/97; 428/95; 428/92; 264/241; 264/243; 264/257

(57) ABSTRACT

Exemplary embodiments of the invention provide a floor mat comprising a base portion defining a floor contact surface, and an absorbent portion in contact with said base portion and surrounding each of a distributed plurality of scrapers, said scrapers integral with said base portion. Exemplary embodiments of the invention provide a method of forming a floor mat, comprising aligning an absorbent portion having a distributed plurality of holes therethrough with a compression mold; and compression molding an elastomeric material onto the absorbent portion and through the distributed plurality of holes to form an base portion and a plurality of distributed scrapers, the base portion integral with the plurality of distributed scrapers. It is emphasized that this abstract is provided to comply with the rules requiring an abstract that will allow a searcher or other reader to quickly ascertain the subject matter of the technical disclosure. This abstract is submitted with the understanding that it will not be used to interpret or limit the scope of the invention.

### BRIEF DESCRIPTION OF THE DRAWINGS

The invention and its wide variety of potential embodiments will be readily understood via the following detailed description of certain exemplary embodiments, with reference to the accompanying drawings in which:

FIG. 1 is a perspective view of an exemplary embodiment of a floor mat 1000 of the present invention;

FIG. 2 is a cross sectional view taken along lines 2-2 of FIG. 1;

FIG. 3 is a perspective view of an exemplary embodiment of a carpet piece 3000 of the present invention;

FIG. 4 is an perspective view of an exemplary embodiment of a first mold portion 4000 of the present invention; and

FIG. 5 is a cross sectional view taken along lines 4-4 of FIG. 4.

### DETAILED DESCRIPTION

Often, when people near an entry and/or enter a building, they prefer to wipe the soles of their shoes on a mat to remove as much debris or moisture as possible, thereby substantially limiting the amount of the debris or moisture that is tracked into the building.

Exemplary embodiments of the invention provide a floor mat comprising a base portion defining a floor contact surface, and an absorbent portion in contact with said base portion and surrounding each of a distributed plurality of scrapers, said scrapers integral with said base portion.

Exemplary embodiments of the invention provide a floor mat comprising an absorbent portion defining a working surface, a base portion bonded to said absorbent portion, and a distributed plurality of scrapers molded from said base portion and extending from said base portion through holes in said absorbent portion to said working surface.

Exemplary embodiments of the invention provide a method of forming a floor mat, comprising aligning an absorbent portion having a distributed plurality of holes therethrough with a compression mold; and compression molding an elastomeric material onto the absorbent portion and through the distributed plurality of holes to form an base portion and a plurality of distributed scrapers, the base portion integral with the plurality of distributed scrapers.

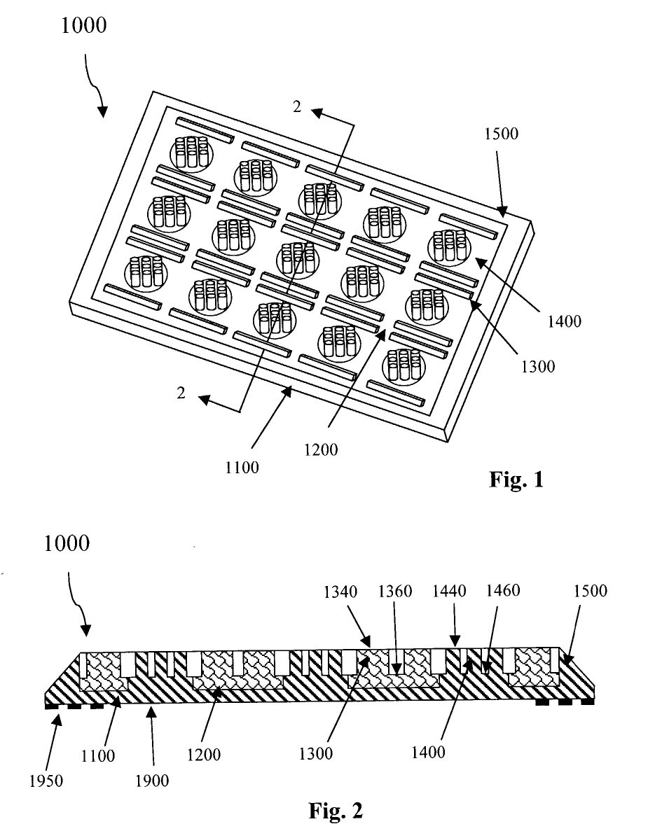

FIG. 1 is a perspective view of an exemplary embodiment of a floor mat 1000 of the present invention, and FIG. 2 is a cross sectional view taken along lines 2-2 of FIG. 1. Referring to FIGS. 1 and 2, floor mat 1000 can include a base portion 1100 in contact with an absorbent portion 1200.

As used herein, the phrase “floor mat” can include a mat, matting, rug, tile, interlocking tile, carpet, floor covering, and/or floor furnishing, etc. As used herein with respect to a floor mat, directional words such as “top”, “bottom”, “above”, “below”, etc. are oriented relative to a mat resting upon a floor, such that an outermost part of the mat in contact with the floor is the “bottom” of the mat, and an opposing outermost surface of the mat is the “top” of the mat, and is above the “bottom” of the mat, etc.

Base portion 1100 can be constructed of a moldable and/or an elastomeric material, such as rubber, natural rubber, SBR rubber, and/or nitrite rubber, etc., and in certain embodiments, can be from approximately 50 to approximately 150 mils thick, and any whole number therebetween. In an exemplary embodiment, the elastomeric material can be a 100 mil thick, black, non-staining, non-marking material having a Shore durometer of 65 plus or minus 5 in a cooled down state.

In certain embodiments, absorbent portion 1200 can be constructed of woven strands, fibers, and/or yarns, etc. of any water absorbent material, including, for example, natural materials such as coir, coco, jute, sisal, grass, cotton, and/or wool, etc., and/or synthetic materials such as nylon, polyamide, polypropylene, polyester, olefin, and/or a water-absorbent polymer, etc., including any such water absorbent materials in a recycled form.

In certain embodiments, absorbent portion 1200 can be constructed of carpet, such as an olefin, polypropylene, tufted, and/or needlepunched, etc. carpet having a primary backing, such as a Typar, 13 pic poly backing. In an exemplary embodiment, the carpet is a 3000 denier yarn, 20 ounce per square yard, 5/32 inch pile, ⅛ gauge tufted polypropylene having a 5 ounce per square yard SBR unitary coating on the back of the material to reduce fraying of the carpet when cut.

Mat 1000 can have any standard mat dimensions, with a length ranging from approximately 6 inches to approximately 180 inches, and any number therebetween, a width ranging from approximately 6 inches to approximately 180 inches, and any number therebetween, and a thickness ranging from approximately 0.25 inches to approximately 1.5 inches, and any 0.0625 inch increment therebetween. In an exemplary embodiment, a mat 1000 can be approximately 24 inches by approximately 36 inches by approximately 0.375 inches.

In certain embodiments, when viewed from above while utilized in a normal position on a floor, mat 1000 can have any shape and any dimensions. For example, mat 1000 can be rectangular, square, trapazoidal, rhomboid, circular, oval, etc., and/or any closed polygon, regular or irregular.

Integral to absorbent portion 1200 and/or having an identical or similar material of construction as absorbent portion 1200 can be a plurality of raised absorbers 1300, which can be distributed randomly on mat 1000 or distributed in any pattern of individual, joined, continuous, contiguous, and/or clustered absorbers. Absorbent portion 1200 and/or absorbers 1300 can define an absorbent wiping surface 1340, which can be substantially planar. Absorbent portion 1200 and/or absorbers 1300 can define an absorbent channeling surface 1360, which can be substantially planar. Although absorbers 1300 can providing at least a partial scraping function, they can also absorb a substantial volume of liquids from the sole of a shoe or foot.

Integral to base portion 1100 and/or having an identical or similar material of construction as base portion 1100 can be a plurality of raised scrapers 1400 extending from base portion 1100 and/or through one or more holes in absorbent portion 1200. Scrapers 1400 can augment the absorbers to provide both a scraping function and an absorbing function in a single mat.

Scrapers 1400 can be distributed randomly on mat 1000 or distributed in any pattern of individual, joined, continuous, contiguous, and/or clustered scrapers. In certain embodiments, several scrapers 1400 can be clustered together to form a group, and several such groups can be distributed about mat 1000 in a patterned and/or random order. In certain embodiments, rather than clustered into groups of scrapers, each scraper can be substantially separated from each other scraper. Various scraping means are envisioned for scraping debris (which can include any unwanted solid) and/or liquids from the soles of the shoes and/or feet. For example, one ore more of the scrapers can be a protrusion, such as a cylindrical bump. One or more of the scrapers can be a ridge. One or a cluster of the scrapers can form a raised closed polygon, and can resemble, for example, shoe soles, feet, animals, letters, numbers, logos, icons, geometric patterns, etc.

Scrapers 1400 can define at least one scraping surface 1440, which can be substantially planar, and which can represent approximately 5% to approximately 50%, and any whole number therebetween (such as for example, 8%, 15%, 20%, 26%, 33%, 42%, etc.) of the visible surface area of mat 1000 when viewed from directly above. Scrapers 1400 can define at least one scraper channeling surface 1460, which can be substantially planar, and that can partially define a channel that at least partially contains debris below scraping surface 1440, to prevent the reattachment of the debris to a sole.

Absorbent wiping surface 1340 can be oriented co-planar, parallel, or along an intersecting plane to scraping surface 1440. If absorbent wiping surface 1340 is co-planar with scraping surface 1440, the co-planar surfaces can define a working surface of mat 1000, which can contact a sole to remove water and debris. Absorbent channeling surface 1360 can be oriented co-planar, parallel, or along an intersecting plane to scraper channeling surface 1460. Absorbent channeling surface 1360 can partially define a channel that at least partially contains debris below absorbent wiping surface 1340, to prevent the reattachment of the debris to a sole. Absorbent channeling surface 1360 can at least partially contain liquids below absorbent wiping surface 1340, to prevent the reattachment of the liquid to a sole.

Integral to base portion 1100 can be an edging 1500 that defines a perimeter of mat 1000 and/or surrounding absorbent portion 1200. Edging 1500 can serve to contain debris and/or liquid within mat 1000.

Base portion 1100 can define at least one floor contact surface 1900 which can include a plurality of integral floor grippers 1950, which can be any shape and/or can be distributed in any manner on base portion 1100, and which can be useful for resisting and/or preventing slippage of mat 1000 on a floor surface.

A volume defined between any of one or more scrapers, clusters of scrapers, one or more absorbers, and/or an edging can be referred to as a channel, which can be useful for at least partially containing debris and/or liquid. Base portion 1100 and/or absorbent portion 1200 can define one or more drain holes to allow liquids absorbed by absorbent portion 1200, and/or debris contained in any channel, to drain and/or exit from mat 1000.

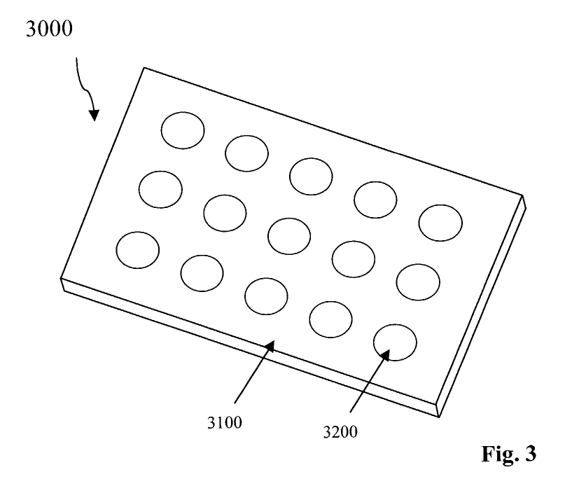

FIG. 3 is a perspective view of an exemplary embodiment of a carpet piece 3000 of the present invention. Carpet piece 3000 can include a substantiallly planar portion of carpet 3100 to which a backing material (not shown) has been applied. Through holes 3200 can be cut in carpet 3100 to correspond to whatever pattern of scrapers and/or scraper clusters (not shown) is desired.

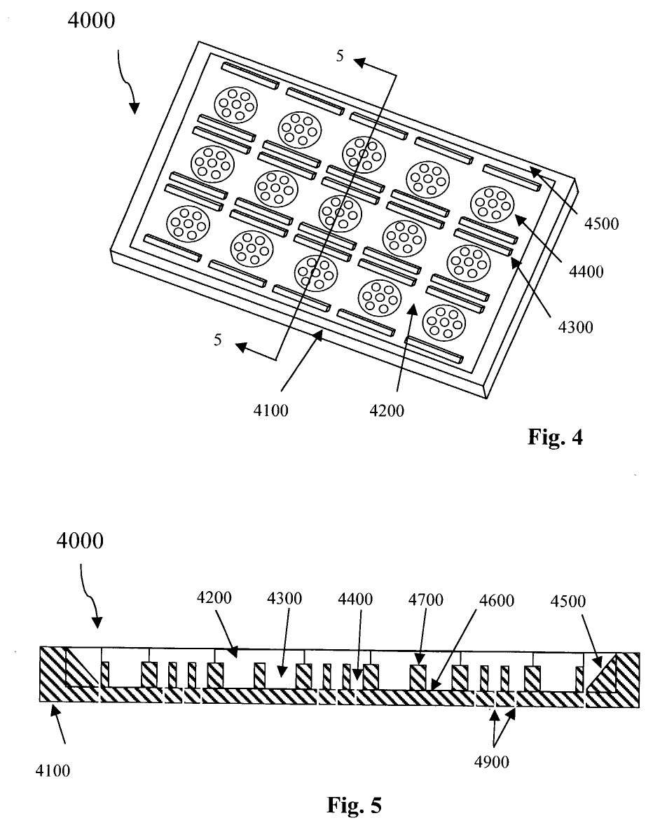

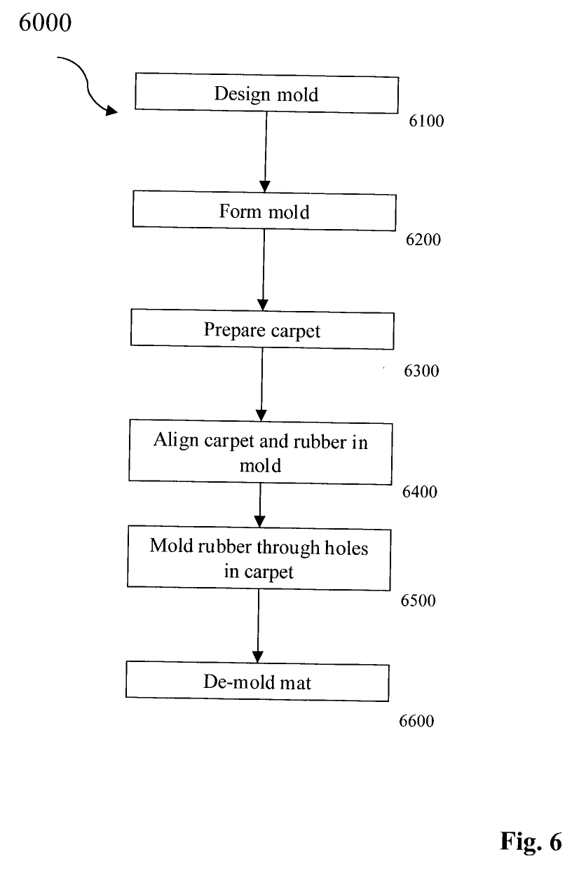

FIG. 4 is an perspective view of an exemplary embodiment of a first mold portion 4000 of the present invention, and FIG. 5 is a cross section taken along lines 4-4 of FIG. 4. Referring to FIGS. 4 and 5, first mold portion 4000 can be a “negative” image of a top view of mat 1000 of FIG. 1, and can include mold plate 4100, which can define an absorbent portion space 4200, an absorber space 4300, a scraper space 4400, and/or an edging space 4500. First mold plate 4100 can define a wiping surface contact area 4340, an absorber channel contact area 4360, a scraper surface contact area 4440, and/or a scraper channel contact area 4460. Sprew holes 4900 can allow ventilation of air and/or outgassing from scraper space 4400. A second mold plate (not shown) can cooperate with first mold portion 4000 to define the floor contact surface and/or floor grippers of mat 1000 shown in FIG. 2.

FIG. 6 is a flow diagram of an exemplary embodiment of a method 6000 of the present invention. Note that although various activities are presented in a numbered sequence, and are connected with arrows to an exemplary embodiment of method 1000, there is no general requirement that the activities be performed in any particular order or any particular number of times, or that all activities be performed. Moreover, any activity can be performed automatically and/or manually.

At activity 6100, a mated pair of mold plates is designed. The design can include overall dimensional parameters for the molds and/or mat, such as length, width, and/or thickness. The design can also include a dimensions, number, pattern, and/or distribution of scrapers, absorbers, edging, and/or floor grippers.

At activity 6200 the mated pair of mold plates can be formed. The plates can be formed of any conventional molding plate material, such as aluminum and/or steel.

At activity 6300, a carpet portion can be prepared for the molding operation. The carpet portion can be cut to the desired dimensions. Holes corresponding to the scrapers can be cut through the carpet. In certain embodiments, the carpet can be die-cut. A styrene-butadiene rubber (SBR) pre-coat can be applied to the carpet portion.

At activity 6400, the prepared carpet, pieces of rubber, and/or a unitary rubber sheet can be positioned and/or aligned with and/or on one or both of the mated pair of mold plates. In certain embodiments, pieces of rubber are aligned in the vicinity of and to form a substantial portion of the scrapers and/or the edging, and a rubber sheet is provided to form a substantial portion of the base portion. For example, in certain embodiments, a homogeneous 100 mil sheet of SBR rubber is provided, and 1 inch wide×100 mil homogeneous strips of SBR rubber are laid around the perimeter of the sheet to reinforce the edging.

At activity 6500, the mold plates containing the mat materials can be placed in a rubber vulcanization press or rubber compression press, and can be compressed onto the mat materials for a predetermined time, temperature, and/or pressure to form the mat. When molded correctly, the rubber can soften and/or melt sufficiently to flow through the holes in the carpet and into the desired predetermined areas of the mold (such as the scraper space and/or the edging space) to assume the shape of the mold in those areas. When multiple pieces of rubber are utilized, those pieces can melt together and/or bond sufficiently to form essentially a single, integral, unitary, monolithic, and/or continuous rubber structure that protrudes through the holes in the carpet portion. When molded correctly, the carpet portion can also conform to the shape of the mold in its respective areas to form the absorbers, absorber channels, etc. Via the molding process, the carpet can bond to the rubber to thereby prevent separation and/or delamination of the absorbent portion from the base portion.

In certain embodiments, using a diaphragm press, the molding parameters can be approximately 20 mats per molding cycle, approximately 350 F to approximately 370 F, approximately 10 to approximately 18 minutes, and/or approximately 55 to approximately 60 psig. In certain embodiments, using a platen press, the molding parameters can be approximately 2 to approximately 4 mats per molding cycle, 320 F to approximately 350 F, approximately 3 to 5 minutes, and/or approximately 150 to approximately 300 psig. The molding parameters can be controlled by a programmable logic controller.

At activity 6600, the mat can be de-molded and/or released from the mold. The mat can be finished of any excess rubber using a teflon-coated fiberglass belt.

A mat formed by an embodiment of a method of the present invention can be used indoor and/or outdoors to simultaneously remove both debris and liquids from the soles of a wearer's shoes, thereby providing a scraping and an absorbing function. The mat can be cleaned by shaking, beating, spraying, and/or washing.

Although the invention has been described with reference to specific embodiments thereof, it will be understood that numerous variations, modifications and additional embodiments are possible, and accordingly, all such variations, modifications, and embodiments are to be regarded as being within the spirit and scope of the invention. Also, references specifically identified and discussed herein are incorporated by reference as if fully set forth herein. Accordingly, the drawings and descriptions are to be regarded as illustrative in nature, and not as restrictive.

What is claimed is:

1. A floor mat, comprising:
a base portion defining a floor contact surface, and
an absorbent portion in contact with said base portion and surrounding each of a distributed plurality of scrapers, said scrapers integral with said base portion.

2. The floor mat of claim 1, each of said scrapers comprising one or more protrusions.

3. The floor mat of claim 1, each of said scrapers comprising one or more cylindrical bumps.

4. The floor mat of claim 1, each of said scrapers comprising one or more ridges.

5. The floor mat of claim 1, said absorbent portion bonded to said base portion.

6. The floor mat of claim 1, said absorbent portion defining a substantially planar absorbent wiping surface.

7. The floor mat of claim 1, said absorbent portion defining a substantially planar absorbent wiping surface and a substantially planar absorbent channeling surface, said channeling surface between said wiping surface and said floor contact surface.

8. The floor mat of claim 1, said distributed plurality of scrapers defining a substantially planar scraping surface.

9. The floor mat of claim 1, said absorbent portion defining a substantially planar absorbent wiping surface, and said distributed plurality of scrapers defining a substantially planar scraping surface, said absorbent wiping surface and said scraping surface substantially coplanar.

10. The floor mat of claim 1, said base portion comprising a plurality of molded floor grippers.

11. The floor mat of claim 1, said base portion comprising an edging surrounding said absorbent portion.

12. The floor mat of claim 1, further comprising an edging surrounding said absorbent portion.

13. The floor mat of claim 1, further comprising an edging surrounding said absorbent portion, said edging integral with said base portion.

14. The floor mat of claim 1, said base portion constructed of an elastomeric material.

15. The floor mat of claim 1, said base portion constructed of rubber.

16. The floor mat of claim 1, said base portion constructed of SBR rubber.

17. The floor mat of claim 1, said base portion constructed of nitrile rubber.

18. The floor mat of claim 1, said scrapers constructed of an elastomeric material.

19. The floor mat of claim 1, said scrapers constructed of rubber.

20. The floor mat of claim 1, said scrapers constructed of SBR rubber.

21. The floor mat of claim 1, said scrapers constructed of nitrile rubber.

22. The floor mat of claim 1, said absorbent portion constructed of carpet.

23. The floor mat of claim 1, said absorbent portion constructed of olefin carpet.

24. The floor mat of claim 1, said absorbent portion constructed of tufted olefin carpet.

25. The floor mat of claim 1, said absorbent portion constructed of polypropylene carpet.

26. The floor mat of claim 1, said absorbent portion constructed of tufted polypropylene carpet.

27. A floor mat, comprising:
a base portion defining a floor contact surface, and
an absorbent portion in contact with said base portion, and
a distributed plurality of scrapers, each of said scrapers surrounded by said absorbent portion, said distributed plurality of scrapers integral with said base portion.

28. A floor mat, comprising:
a base portion defining a floor contact surface, and
a absorbent portion in contact with said base portion, a plurality of openings defined in said absorbent portion, and
a plurality of scrapers, extending from said base portion and through said openings.

29. A floor mat, comprising:
a base portion, and
a working surface defined by an absorbent portion in contact with said base portion and further defined by a plurality of scrapers, each scraper from said plurality of scrapers extending from said base to said working surface.

30. A floor mat, comprising:
an absorbent portion defining a working surface,
a base portion bonded to said absorbent portion, and
a distributed plurality of scrapers molded from said base portion and extending from said base portion through holes in said absorbent portion to said working surface.

31. A floor mat, comprising:
a base portion defining a floor contact surface, and
a plurality of scraping means for scraping debris from a sole of a shoe, said plurality of scraping means integral with said base portion and surrounded by an absorbent portion in contact with said base portion.

32. A floor mat, comprising:
a base portion defining a floor contact surface, and
a plurality of scraping means for scraping debris from a sole of a shoe, said plurality of scraping means integral with said base portion and extending from said base portion through holes in an absorbent portion in contact with said base portion.

33. A method of forming a floor mat, comprising:
aligning an absorbent portion having a distributed plurality of holes therethrough with a compression mold; and
compression molding an elastomeric material onto the absorbent portion and through the distributed plurality of holes to form an base portion and a plurality of distributed scrapers, the base portion integral with the plurality of distributed scrapers.

34. The method of claim 33, further comprising cutting the distributed plurality of holes through the absorbent portion.

35. The method of claim 33, further comprising designing the compression mold.

36. The method of claim 33, further comprising forming the compression mold.

37. The method of claim 33, further comprising providing the compression mold.

38. The method of claim 33, wherein the compression mold defines an absorbent portion molding pattern.

39. The method of claim 33, wherein the compression mold defines a base portion molding pattern.

40. The method of claim 33, wherein the compression mold defines a scraper molding pattern.

41. The method of claim 33, wherein the compression mold defines a plurality of through holes corresponding to the plurality of distributed scrapers.

42. The method of claim 33, further comprising contacting the absorbent portion with the elastomeric material.

43. The method of claim 33, further comprising contacting the absorbent portion with the compression mold.

44. The method of claim 33, further comprising contacting a sheet of elastomeric material with the compression mold.

45. The method of claim 33, further comprising contacting a sheet of elastomeric material and additional pieces of elastomeric material with the compression mold.

46. The method of claim 33, further comprising releasing a floor mat from the compression mold.

47. The method of claim 33, wherein the absorbent portion and the elastomeric material are compression molded at a predetermined temperature.

48. The method of claim 33, wherein the absorbent portion and the elastomeric material are compression molded at a predetermined pressure.

49. The method of claim 33, wherein the absorbent portion and the elastomeric material are compression molded for a predetermined time.

50. The method of claim 33, wherein the elastomeric material is compression molded for a predetermined time.
